(19) United States
(12) Patent Application Publication
(10) Pub. No.: US 2023/0110592 A1
(43) Pub. Date: Apr. 13, 2023

(54) CONSTRUCTION SYSTEM FOR RECURRENT BAYESIAN NETWORKS, CONSTRUCTION METHOD FOR RECURRENT BAYESIAN NETWORKS, COMPUTER READABLE RECORDING MEDIUM, NON-TRANSITORY COMPUTER PROGRAM PRODUCT, AND RADIO NETWORK CONTROL SYSTEM

(71) Applicant: Wistron Corporation, New Taipei City (TW)

(72) Inventor: Chih-Ming Chen, New Taipei City (TW)

(21) Appl. No.: 17/839,742

(22) Filed: Jun. 14, 2022

(30) Foreign Application Priority Data
Oct. 13, 2021 (TW) 110137963
Mar. 9, 2022 (TW) 111108574
Mar. 16, 2022 (TW) 111109714

(51) Int. Cl. H04W 16/18

(52) U.S. Cl. CPC H04W 16/18; H04W 84/18

(57) ABSTRACT

A construction system for recurrent Bayesian networks, a construction method for recurrent Bayesian networks, a computer-readable recording medium, a non-transitory computer program product, and a radio network control system are provided. The method is performed by a processor, and includes: establishing an initial population, and setting the initial population as a current population; establishing a corresponding recurrent Bayesian network for each CPPN in the current population, to obtain a set of recurrent Bayesian networks corresponding to the current population; evolving the current population by using an evolutionary algorithm and a fitness function to obtain a next population; determining whether a termination condition is met; and repeatedly performing the foregoing steps in response to the termination condition being not met, and selecting a solution network in the current population as the task network based on the fitness function in response to the termination condition being met.

### CROSS-REFERENCES TO RELATED APPLICATIONS

This non-provisional application claims priority under 35 U.S.C. § 119(a) to Patent Application No. 110137963 filed in Taiwan, R.O.C. on Oct. 13, 2021, Patent Application No. 111108574 filed in Taiwan, R.O.C. on Mar. 9, 2022, and Patent Application No. 111109714 filed in Taiwan, R.O.C. on Mar. 16, 2022, the entire contents of which are hereby incorporated by reference.

### BACKGROUND

### Technical Field

The present invention relates to genetic algorithm technologies applied to recurrent Bayesian networks, and in particular, to recurrent Bayesian networks of a radio network control system.

### Related Art

Self-organizing network (SON) refers to the minimization of human intervention in mobile network automation and cellular/radio network management. This concept is introduced in the 8^{th} release of 3GPP. The main objectives of the self-organizing network may be roughly divided into three points: first, introducing intelligence and autonomous adaptability to cellular networks; second, reducing capital and operating expenses; and third, improving network performance in terms of network capacity, coverage, and provided services and experience. However, many operations of the existing self-organizing network solutions on the market are still completed manually (for example, network failures are usually repaired directly). Moreover, many operations are still completed by operating personnel (for example, network failures are usually repaired directly by engineers). Some open challenges still remain unsolved, such as coordination of self-organizing network functions, or proper balance between centralized and distributed self-organizing network implementations.

Recurrent Bayesian networks have the advantage of modeling causal relationships between problem features as dependencies between random variables by using prior knowledge, and processing inherent uncertainty in problem tasks. However, training a large recurrent Bayesian network usually needs a large quantity of training samples to learn something useful from the data. Moreover, a structure of a to-be-trained recurrent Bayesian network is pre-specified, which may lead to poor utilization efficiency of computing resources.

### SUMMARY

In view of this, some embodiments of the present invention provide a construction system for recurrent Bayesian networks, a construction method for recurrent Bayesian networks, a computer-readable recording medium, a non-transitory computer program product, and a radio network control system to alleviate the problems in the prior art.

An embodiment of the present invention provides a construction system for recurrent Bayesian networks, including at least one processor. The at least one processor is configured to perform the following steps to generate a task network: establishing an initial population, the initial population including a plurality of compositional pattern-producing networks (CPPNs), and setting the initial population as a current population; establishing a corresponding recurrent Bayesian network for each CPPN in the current population, to obtain a set of recurrent Bayesian networks corresponding to the current population; evolving the current population by using an evolutionary algorithm and a fitness function to obtain a next population, and setting the next population as the current population; determining whether a termination condition is met according to the fitness function and the set of recurrent Bayesian networks corresponding to the current population; and repeatedly performing the foregoing steps in response to the termination condition being not met, and selecting a solution network in the current population as the task network according to the fitness function in response to the termination condition being met.

An embodiment of the present invention provides a construction method for recurrent Bayesian networks, performed by a processor. The construction method for recurrent Bayesian networks is used to generate a task network. The construction method for recurrent Bayesian networks includes: establishing an initial population, the initial population including a plurality of CPPNs, and setting the initial population as a current population; establishing a corresponding recurrent Bayesian network for each CPPN in the current population, to obtain a set of recurrent Bayesian networks corresponding to the current population; evolving the current population by using an evolutionary algorithm and a fitness function to obtain a next population, and setting the next population as the current population; determining whether a termination condition is met according to the fitness function and the set of recurrent Bayesian networks corresponding to the current population; and repeatedly performing the foregoing steps in response to the termination condition being not met, and selecting a solution network in the current population as the task network according to the fitness function in response to the termination condition being met.

Some embodiments of the present invention provide a computer-readable recording medium with a stored program. The stored program, when loaded and executed by a processor, can perform the foregoing construction method for recurrent Bayesian networks.

An embodiment of the present invention provides a radio network control system. The radio network control system applies a task network generated by the foregoing construction system for recurrent Bayesian networks. The radio network control system is coupled to a radio access network (RAN), and includes an optimizer and a control unit. The optimizer is configured to receive a network state and a target policy of the radio access network, and output an optimal configuration to the radio access network for configuring and optimizing the radio access network. The control unit includes the foregoing task network. The optimizer inputs a plurality of configuration feature vectors of each solution to the control unit based on a plurality of solutions in a solution space. The task network evaluates at least one key performance indicator (KPI) of each configuration feature vector to obtain a KPI value of each configuration feature vector. The optimizer selects an optimal solution in the solution space based on the KPI value of each configuration feature vector. The optimizer outputs an optimal configuration to the RAN based on the optimal solution.

Based on the above, some embodiments of the present invention provide a construction system and construction method for recurrent Bayesian networks, a computer-readable recording medium, and a non-transitory computer program product, which can efficiently construct an appropriate recurrent Bayesian network by evolving a population consisting of CPPNs. Some embodiments of the present invention provide a radio network control system that can automatically complete a self-organizing network solution by applying a task network generated by the construction system for recurrent Bayesian networks.

### BRIEF DESCRIPTION OF THE DRAWINGS

FIG. 1 is a block diagram of a construction system for recurrent Bayesian networks according to an embodiment of the present invention;

FIG. 2 is a schematic diagram of a CPPN according to an embodiment of the present invention;

FIG. 3 is a schematic diagram of neural network encoding according to an embodiment of the present invention;

FIG. 4 is a schematic diagram of a neural network mutation process according to an embodiment of the present invention;

FIG. 5 is a schematic diagram of a neural network crossover process according to an embodiment of the present invention;

FIG. 6-1 is a schematic diagram of a Bayesian network according to an embodiment of the present invention;

FIG. 6-2 is a schematic diagram of a Bayesian network according to an embodiment of the present invention;

FIG. 7 is a schematic diagram of a recurrent Bayesian network according to an embodiment of the present invention;

FIG. 8 is a schematic diagram of constructing a recurrent Bayesian network according to an embodiment of the present invention;

FIG. 9 is a flowchart of a construction method for recurrent Bayesian networks according to an embodiment of the present invention;

FIG. 10 is a flowchart of a construction method for recurrent Bayesian networks according to an embodiment of the present invention;

FIG. 11 is a flowchart of a construction method for recurrent Bayesian networks according to an embodiment of the present invention;

FIG. 12 is a structural block diagram of an electronic device according to an embodiment of this specification; and

FIG. 13 is a block diagram of a radio network control system in which a task network generated by a construction system for recurrent Bayesian networks is applied.

### DETAILED DESCRIPTION

The foregoing and other technical contents, features, and effects of the present invention can be clearly presented below in detailed description with reference to embodiments of the accompanying drawings. Proportions or sizes of the components in the drawings expressed in an exaggerated, omitted or general manner are used to help a person skilled in the art to understand and read, and are not intended to limit restraint conditions under which the present invention can be implemented and therefore have no technical significance. Any modification to the structure, change to the proportional relationship or adjustment on the size should fall within the scope of the technical content disclosed by the present invention without affecting the effects and the objectives that can be achieved by the present invention. The same reference numerals are used to indicate the same or similar components in all of the accompanying drawings. The term “couple” or “connect” provided in the following embodiments may refer to any direct or indirect, or wired or wireless connection means.

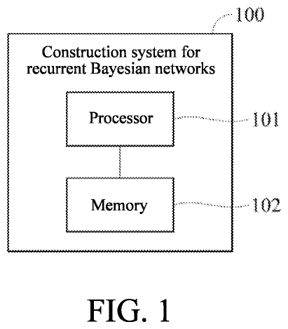

FIG. 1 is a block diagram of a construction system for recurrent Bayesian networks according to an embodiment of the present invention. Referring to FIG. 1, a construction system 100 for recurrent Bayesian networks includes a processor 101 and a memory 102. The memory 102 is configured to store an intermediate result that needs to be temporarily stored during a calculation process. It should be noted that, although a single processor 101 is shown in FIG. 1, the construction system 100 for recurrent Bayesian networks may also be configured with a plurality of processors to accelerate computing.

A construction method for recurrent Bayesian networks and collaboration between modules of the construction system 100 for recurrent Bayesian networks according to the embodiments of the present invention are described in detail below with reference to the accompanying drawings.

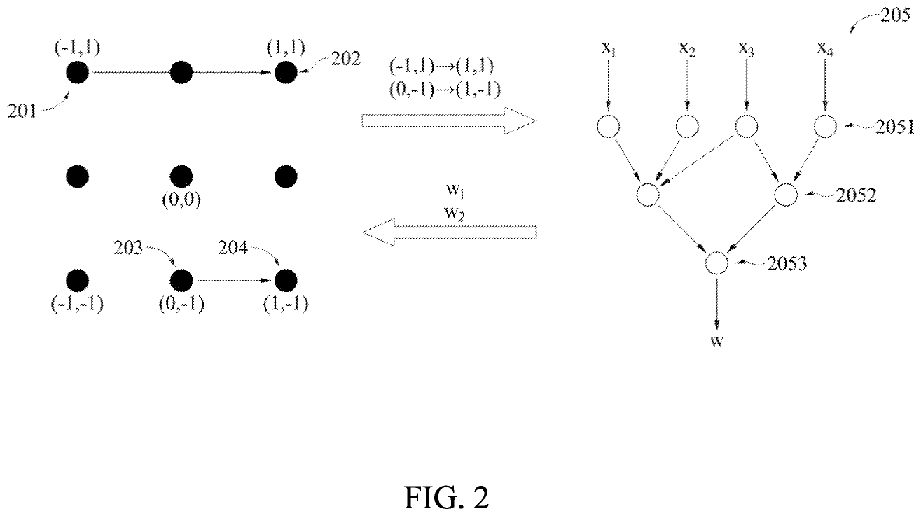

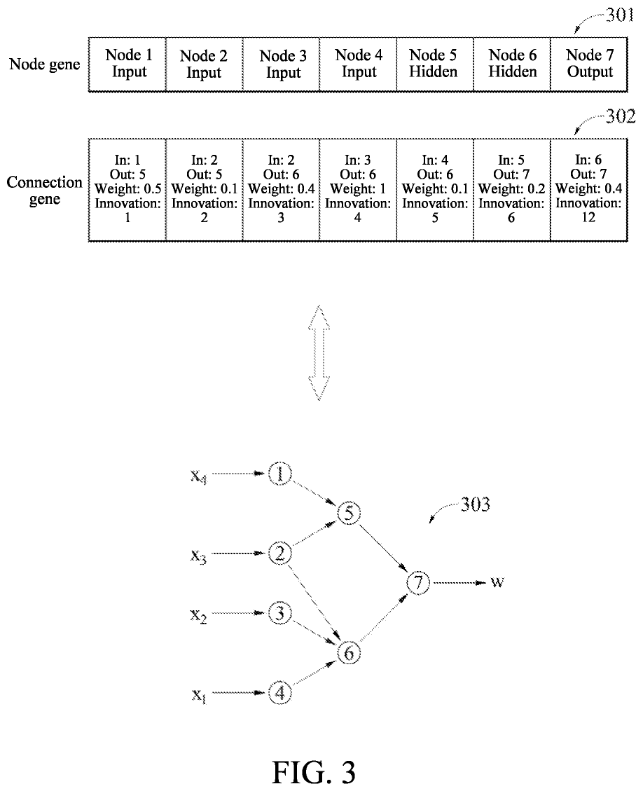

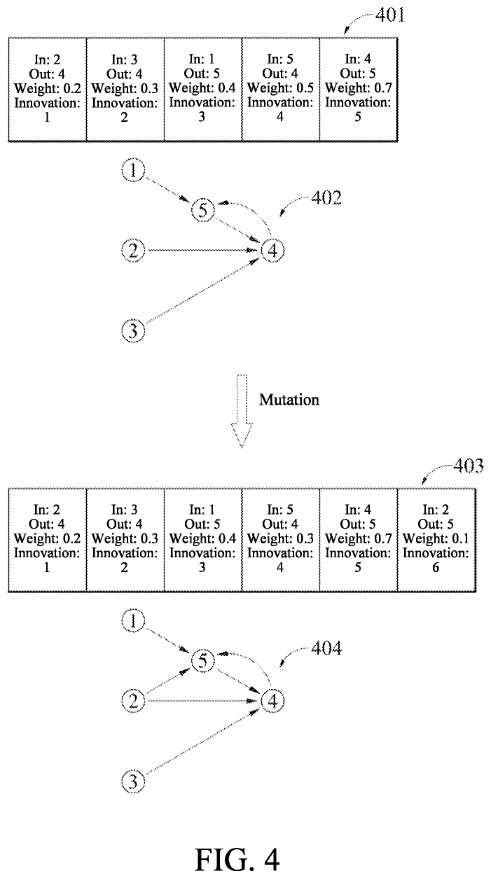

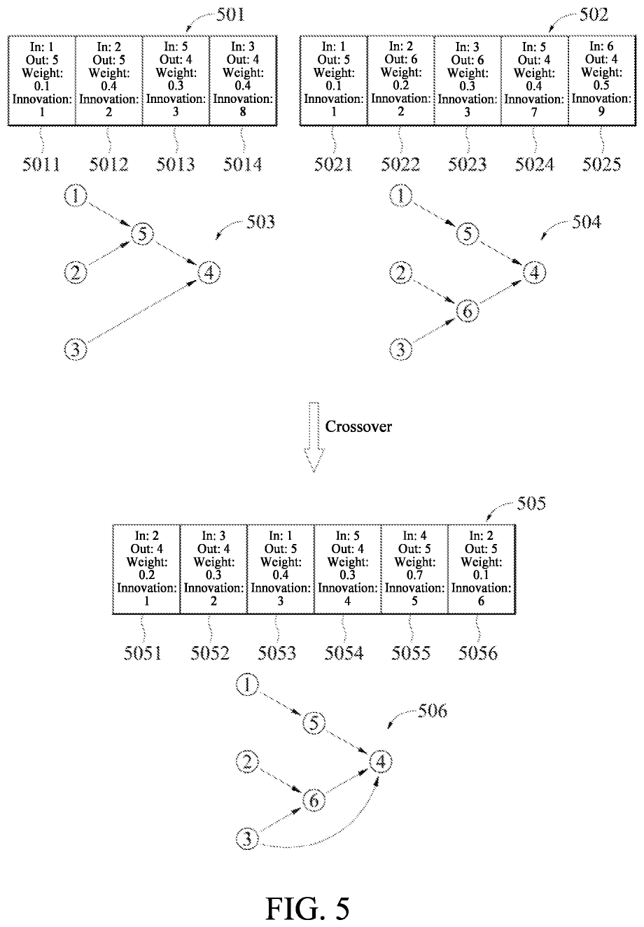

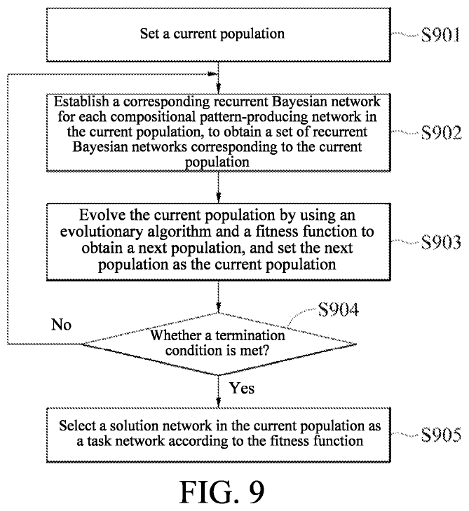

FIG. 2 is a schematic diagram of a CPPN according to an embodiment of the present invention. FIG. 3 is a schematic diagram of neural network encoding according to an embodiment of the present invention. FIG. 4 is a schematic diagram of a neural network mutation process according to an embodiment of the present invention. FIG. 5 is a schematic diagram of a neural network crossover process according to an embodiment of the present invention. FIG. 9 is a flowchart of a construction method for recurrent Bayesian networks according to an embodiment of the present invention. First, refer to FIG. 2 to FIG. 5, and FIG. 9 together.

In the embodiment shown in FIG. 9, the CPPN is a neural network. Taking the CPPN 205 shown in FIG. 2 as an example, the CPPN 205 includes an input layer 2051, a hidden layer 2052, and an output layer 2053. Each node of the hidden layer 2052 may adopt different activation functions, such as a trigonometric sine function, or a Gaussian function. It should be noted that the CPPN 205 is only used to describe a general CPPN. The present invention is not limited to the connection relationship of the CPPN 205.

A connection pattern of the neural network may be stored as a four-dimensional hypercube by using the CPPN. Each point of the four-dimensional hypercube may be represented as (x₁, y₁, x₂, y₂), where x₁, y₁, x₂, and y₂ are coordinate components of each point of the four-dimensional hypercube. Each point encodes a connection between two nodes. The CPPN 205 may be considered as a four-dimensional function CPPN(1):

w=CPPN(x₁,y₁,x₂,y₂) (1).

w is an output value of the CPPN 205. As shown in FIG. 2, a connection weight between a node (x₁, y₁) and a node (x₂, y₂) may be obtained by inputting (x₁, y₁, x₂, y₂) into the four-dimensional function CPPN(1). The obtained output w is the connection weight between the node (x₁, y₁) and the node (x₂, y₂). For example, as shown in FIG. 2, because an output of the four-dimensional function CPPN(1) corresponding to (−1, 1, 1, 1) is w₁, a connection weight between a node 201 (encoded as (−1, 1)) and a node 202 (coded as (1, 1)) is w₁. Because an output of the four-dimensional function CPPN(1) corresponding to (0, −1, 1, −1) is w₂, a connection weight between a node 203 (encoded as (0, −1)) and a node 204 (encoded as (1, −1)) is w₂. It should be noted that, in this embodiment, a minimum threshold wₘᵢₙ is pre-specified. When the output w is less than the minimum threshold wₘᵢₙ, it indicates that the two nodes are not connected. In the foregoing manner, the CPPN 205 and the corresponding four-dimensional function CPPN(1) may establish a corresponding neural network topology.

Referring to FIG. 3, a neural network may be generally represented by numbering nodes and connections of the general neural network, so that the neural network may perform an evolution operation. For example, as shown in FIG. 3, nodes of the CPPN 205 are numbered 1 to 7, to obtain a CPPN 303 after the numbering. After the numbering, the CPPN 303 may be expressed as a node gene 301 and a connection gene 302. “Input” recorded in the node gene 301 represents that the node is an input node. “Output” recorded in the node gene 301 represents that the node is an output node. “Hidden” recorded in the node gene 301 represents that the node is a hidden node. “In” recorded in the connection gene 302 represents an initial node of the connection. “Out” recorded in the connection gene 302 represents an end node of the connection. “Weight” recorded in the connection gene 302 represents a weight value of the connection. “Innovation” recorded in the connection gene 302 represents an innovation value of the connection. The innovation value of the connection is used to match a genome during a crossover process in the neural network evolutionary operation, and use of the innovation value of the connection will be further described in the following embodiments.

After the neural network is expressed as the node gene 301 and the connection gene 302, as shown in FIG. 3, the neural network may further perform an evolutionary operation. As shown in FIG. 4, a neural network 402 includes a connection gene 401. By randomly adding a connection gene element to the connected gene 401, for example, a connection gene element in which “in” is 2, “out” is 5, “weight” is 0.1, and “innovation” is 6 in the connection gene 403, the connection gene 403 corresponds to a neural network 404. A process that the neural network 402 evolves to the neural network 404 is referred to as a neural network mutation process.

It should be noted that, the random addition of an element to the connection gene 401 may be implemented by randomly generating appropriate “in”, “out”, “weight”, and “innovation” through a random simulation function (for example, a random ( ) function in a random module in Python) of general software.

Referring to FIG. 5, a neural network 503 includes a connection gene 501. The connection gene 501 includes connection gene elements 5011, 5012, 5013, and 5014. A neural network 504 includes a connection gene 502. The connection gene 502 includes connection gene elements 5021, 5022, 5023, 5024, and 5025. To perform a crossover process in the neural network evolutionary operation on the neural network 503 and the neural network 504 to generate a new neural network, first, connection gene elements of the two connection genes are matched based on “innovation” values. For example, as shown in FIG. 5, the connection gene element 5011 matches the connection gene element 5021, the connection gene element 5012 matches the connection gene element 5022, and the connection gene element 5013 matches the connection gene element 5023. The connection gene element 5014 does not match any connection gene element of the connection gene 502; the connection gene element 5024 and the connection gene element 5025 do not match any connection gene elements of the connection gene 501. For the matched gene elements, one of the matched gene elements is randomly selected and placed into a connection gene of the new neural network.

In the foregoing example, the connection gene element 5011 matches the connection gene element 5021. Therefore, one of the connection gene element 5011 and the connection gene element 5021 is randomly selected and placed into a connection gene 505 of a neural network 506. The connection gene element 5012 matches the connection gene element 5022. Therefore, one of the connection gene element 5012 and the connection gene element 5022 is randomly selected and placed into the connection gene 505 of the neural network 506, and so on. The connection gene elements that are not matched, such as the connection gene elements 5014, 5024, or 5025, are unconditionally placed into the connection gene 505 of the neural network 506. Finally, the connection gene 505 and the corresponding neural network 506 may be obtained. The connection gene 505 includes connection gene elements 5051, 5052, 5053, 5054, 5055, and 5056. The neural network 503 and the neural network 504 are referred to as parents of the neural network 506. The neural network 506 is referred to as an offspring of the neural network 503 and the neural network 504.

The algorithms for evolving the topological structure and the connection weights of the neural network shown in FIG. 3 to FIG. 5 are referred to as neuroevolution of augmenting topologies.

It should be noted that the process of randomly selecting one of the connection gene element 5012 and the connection gene element 5022 may be implemented by randomly selecting one of the connection gene element 5012 and the connection gene element 5022 through a random simulation function (for example, a random( ) function in a random module in Python) of general software.

In step S901 in FIG. 9, the processor 101 establishes an initial population, and sets the initial population as a current population. The initial population includes a plurality of CPPNs randomly generated by the processor 101 (for example, the CPPN 205 shown in FIG. 2). The quantity of initial populations is a preset population quantity M, and M is a positive integer. Moreover, the processor 101 sets the initial population as the current population. The processor 101 further receives an external fitness function to evolve the current population. It should be noted that the processor 101 may use a random simulation function (for example, each random function in a random module in Python) provided by general software to randomly generate values in the node genes and the connection genes (as shown in FIG. 3) to randomly generate a CPPN.

FIG. 6-1 and FIG. 6-2 are schematic diagrams of a Bayesian network according to an embodiment of the present invention. Before step S902 is described, first, refer to FIG. 6-1 and FIG. 6-2. A Bayesian network is a probability graphical model that represents a set of random variables {X₁, X₂, . . . , and Xₙ} and their properties of n sets of conditional probability distributions (CPDs) by using directed acyclic graphs (DAGs). For example, the Bayesian network may be used to represent a probability relationship between diseases and related symptoms of the diseases. In a case that a certain symptom is known, the Bayesian network may be used to calculate the probability of various possible diseases. Generally, nodes of the Bayesian network represent random variables, which may be observable variables, latent variables, unknown parameters, or the like. An arrow connecting two nodes indicates that the two random variables are causally related or conditionally dependent. If the two nodes are not connected by an arrow, the random variables are referred to as conditionally independent of each other. If the two nodes are connected by a single arrow, it indicates that one node is a parent node and the other node is an offspring node. The offspring node generates a conditional probability value for the parent node.

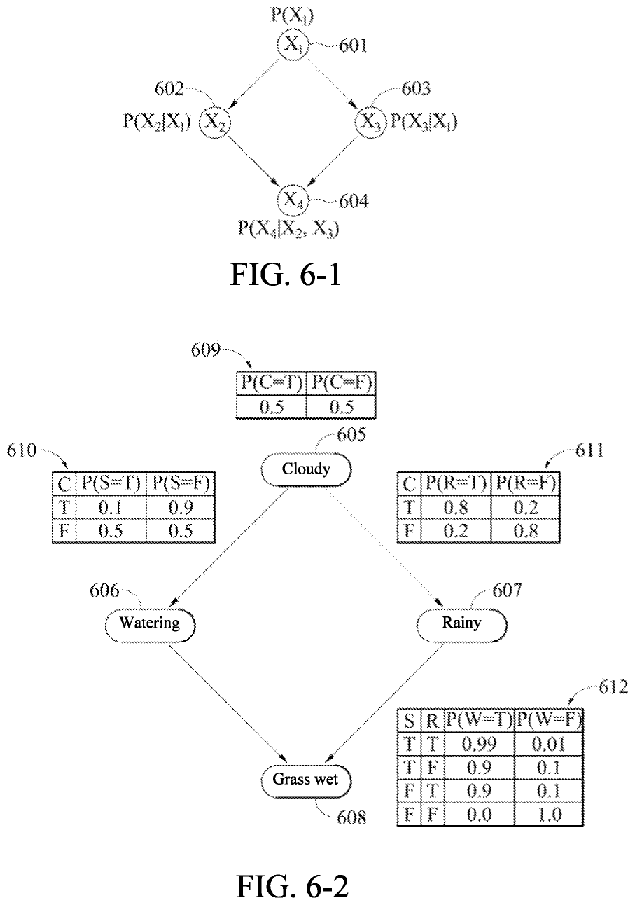

FIG. 6-1 shows a Bayesian network, including a node 601 (represented by a random variable X₁), a node 602 (represented by a random variable X₂), a node 603 (represented by a random variable X₃), and a node 604 (represented by a random variable X₄). An arrow is connected between the node 601 (represented by the random variable X₁) and the node 602 (represented by the random variable X₂), indicating that the two random variables X₁ and X₂ are causally related or conditionally dependent. Moreover, the node 601 (represented by the random variable X₁) is a parent node, and the other node 602 (represented by the random variable X₂) is an offspring node. The node 601 (represented by the random variable X₁) and the node 602 (represented by the random variable X₂) generate a conditional probability P(X₂|X₁). The node 601 (represented by the random variable X₁) and the node 603 (represented by the random variable X₃) generate a conditional probability P(X₃|X₁). The node 604 (represented by the random variable X₄), the node 602 (represented by the random variable X₂) and the node 603 (represented by the random variable X₃) generate a conditional probability P(X₄|X₂, X₃). P(X₁) represents a probability of the node 601 (represented by the random variable X₁).

In an embodiment of the present invention, properties of the Bayesian network on the nodes are discrete. In this embodiment, the conditional probabilities may be represented by using a conditional probability table (CPT). A sum of probabilities in any row of the CPT is definitely 1. Taking the Bayesian network shown in FIG. 6-2 as an example, a node 605 represents a cloudy random variable C, a node 606 represents a watering random variable S, a node 607 represents a rainy random variable R, and a node 608 represents a grass-wet random variable W. Values of the random variables C, S, R, and W are all selected from a set {T,F}. T and F are elements of the set. T represents occurred, and F represents not occurred. P(C) is represented by a probability table 609. P(S|C) is represented by a CPT 610. P(R|C) is represented by a CPT 611. P(W|S, R) is represented by a CPT 612.

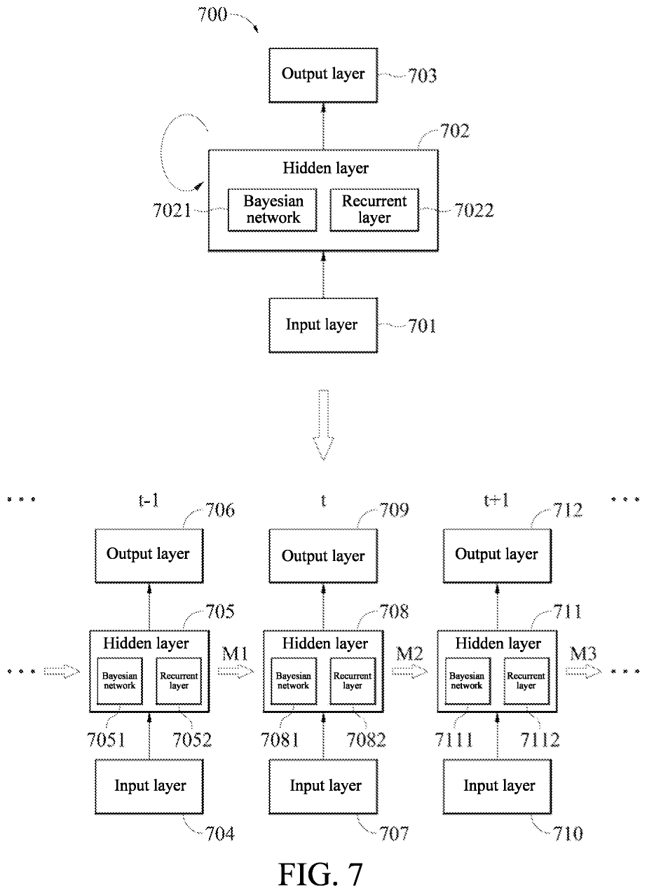

FIG. 7 is a schematic diagram of a recurrent Bayesian network according to an embodiment of the present invention. As shown in FIG. 7, the recurrent Bayesian network 700 includes an input layer 701, a hidden layer 702, and an output layer 703. The hidden layer 702 includes a Bayesian network 7021 and a recurrent layer 7022. The recurrent layer 7022 is used to record a state of the Bayesian network, and add, at a next moment, a state recorded at a current moment to an input of the next moment. An operation of the recurrent Bayesian network 700 over time is shown in the lower part of FIG. 7. An output layer 706 at a time point t−1, an output layer 709 at a time point t, and an output layer 712 at a time point t+1 correspond to the output layer 703. An input layer 704 at the time point t−1, an input layer 707 at the time point t, and an input layer 710 at the time point t+1 correspond to the input layer 701. A hidden layer 705 at the time point t−1, a hidden layer 708 at the time point t, and a hidden layer 711 at the time point t+1 correspond to the hidden layer 702. A Bayesian network 7051 and a recurrent layer 7052 of the hidden layer 705 at the time point t−1, a Bayesian network 7081 and a recurrent layer 7082 of the hidden layer 708 at the time point t, and a Bayesian network 7111 and a recurrent layer 7112 of hidden layer 711 at the time point t+1 correspond to the Bayesian network 7021 and the recurrent layer 7022 of the hidden layer 702. At the time point t-1, the hidden layer 705 stores a node state M1 in the recurrent layer 7052. At the time point t, the node state M1 is inputted into the hidden layer 708. Similarly, at the time point t, the hidden layer 705 stores a node state M2 in recurrent layer 7082. At the time point t+1, the node state M2 is inputted into the hidden layer 711. Similarly, at the time point t+1, the hidden layer 711 stores a node state M3 in the recurrent layer 7112, and so on.

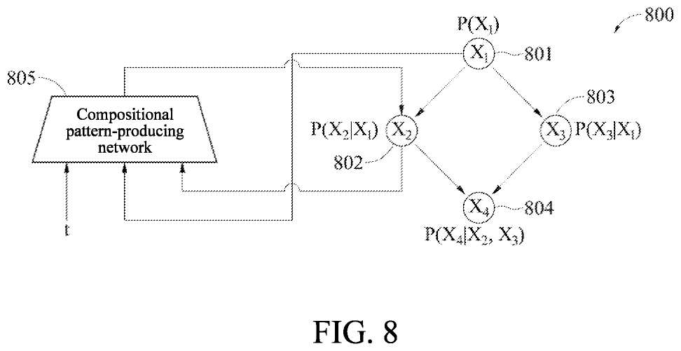

FIG. 8 is a schematic diagram of constructing a recurrent Bayesian network according to an embodiment of the present invention; Refer to FIG. 8 and FIG. 9 together. In step S902, the processor 101 establishes a corresponding recurrent Bayesian network for each CPPN in the current population. The foregoing method for establishing a corresponding recurrent Bayesian network is described below by taking FIG. 8 as an example. For the CPPN 805, for all the time points t, the CPPN 805 takes all possible node pairs of the Bayesian network 800 of the recurrent Bayesian network at the time point t (for example, a node 801 shown in FIG. 8 (represented by a random variable X₁) and a node 802 (represented by a random variable X₂)) as an input, to obtain a conditional probability P(X₂|X₁). It should be noted that, if the two nodes of the input are not causally related or conditionally independent, the output of the CPPN 805 is 0. In this way, the Bayesian network 800 of the recurrent Bayesian network at the time point t may be established through the CPPN 805. The Bayesian network 800 of the recurrent Bayesian network at the time point t includes the node 801 (represented by the random variable X₁), the node 802 (represented by the random variable X₂), a node 803 (represented by a random variable X₃), and a node 804 (represented by a random variable X₄). Moreover, a conditional probability of the node 802 (represented by the random variable X₂) to the parent node 801 (represented by the random variable X₁) is P(X₂|X₁). A conditional probability of the node 803 (represented by the random variable X₃) to the parent node 801 (represented by the random variable X₁) is P(X₃|X₁). A conditional probability of the node 804 (represented by the random variable X₄) to the parent node 802 (represented by the random variable X₂) and the parent node 803 (represented by the random variable X₃) is P(X₄|X₂, X₃). P(X₁) represents a probability of the node 801 (represented by the random variable X₁).

The processor 101 establishes a corresponding recurrent Bayesian network for each CPPN in the current population by using the foregoing establishment method. Therefore, the processor 101 finally can obtain a set of recurrent Bayesian networks corresponding to the current population.

In step S903, the processor 101 evolves the current population by using an evolutionary algorithm and a fitness function to obtain a next population, and sets the next population as the current population. In an embodiment of the present invention, the processor 101 calculates a fitness value of each CPPN in the current population by using the fitness function, and ranks each CPPN in the current population by using the fitness value of each CPPN in the current population. The processor 101 selects N CPPNs in the current population with larger fitness values based on the ranking result, where N is a positive integer, and N is less than the population quantity M. The processor 101 then operates the selected N CPPNs by using the mutation process and the crossover process in the neural network evolutionary operation shown in FIG. 4 and FIG. 5, so that the N CPPNs are expanded to the population quantity M to obtain the next population. The processor 101 then sets the next population as the current population to continue the next step.

In an embodiment of the present invention, the process in which the processor 101 operates the selected N CPPNs by using the mutation process and the crossover process in the neural network evolutionary operation shown in FIG. 4 and FIG. 5 includes: The processor 101 randomly performs the mutation process and the crossover process on the N CPPNs according to a crossover probability. The crossover probability is, for example, 0.8. In this case, there is an 80% chance that the processor 101 performs the crossover process on the N CPPNs, and there is an 20% chance that the processor 101 performs the mutation process on the N CPPNs.

It should be noted that, any neural evolutionary algorithm based on the neuroevolution of augmenting topologies for evolving the topological structures and connection weights of the neural network as shown in FIG. 3 to FIG. 5 is applicable to evolution of the current population. The invention is not limited to the aforementioned embodiments.

In step S904, the processor 101 determines whether a termination condition is met according to the fitness function and the set of recurrent Bayesian networks corresponding to the current population. In this embodiment, the termination condition is that steps S902 and S903 are performed for a default number of times, or, according to the fitness function, the current population includes a candidate network allowing a fitness value of the candidate network to be greater than a preset fitness value. If the termination condition is not met, the processor 101 executes steps S902 and S903 again. If the termination condition is met, the processor 101 executes step S905.

In step S905, because the current population already includes at least one candidate network that the fitness value of the candidate network to be greater than the preset fitness value. The processor 101 then selects a solution network in the current population, whose fitness value is greater than the preset fitness value, as the task network according to the fitness function.

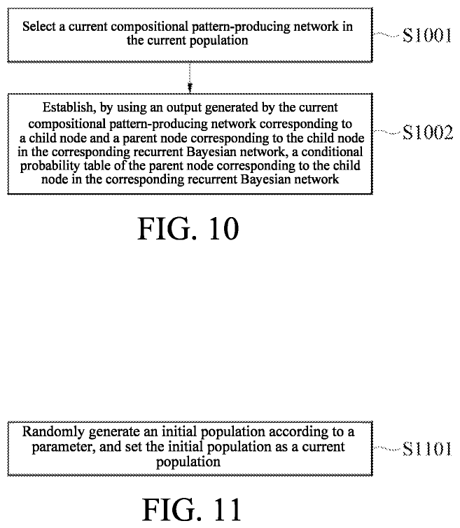

FIG. 10 is a flowchart of a construction method for recurrent Bayesian networks according to an embodiment of the present invention. In the embodiment shown in FIG. 10, properties of the Bayesian network on nodes are discrete. The foregoing step S902 includes steps S1001 and S1002. In step S1001, the processor 101 selects a current CPPN in the current population. In step S1002, the processor 101 establishes, by using an output generated by the current CPPN corresponding to an offspring node and a parent node corresponding to the offspring node in the recurrent Bayesian network, a CPT of the parent node corresponding to the offspring node in the corresponding recurrent Bayesian network, to establish a corresponding recurrent Bayesian network.

FIG. 11 is a flowchart of a construction method for recurrent Bayesian networks according to an embodiment of the present invention. In the embodiment shown in FIG. 11, the foregoing step S901 further includes step S1101. In step S1101, the processor 101 randomly generates an initial population according to a parameter. In this embodiment, the parameter is a value generated by the processor 101 based on a time point at which the processor 101 starts performing step S901. The processor 101 then initializes a simulation random function (for example, a random( ) function in a random module in Python) of general software according to the value to randomly generate an initial population. The processor 101 then sets the initial population as the current population.

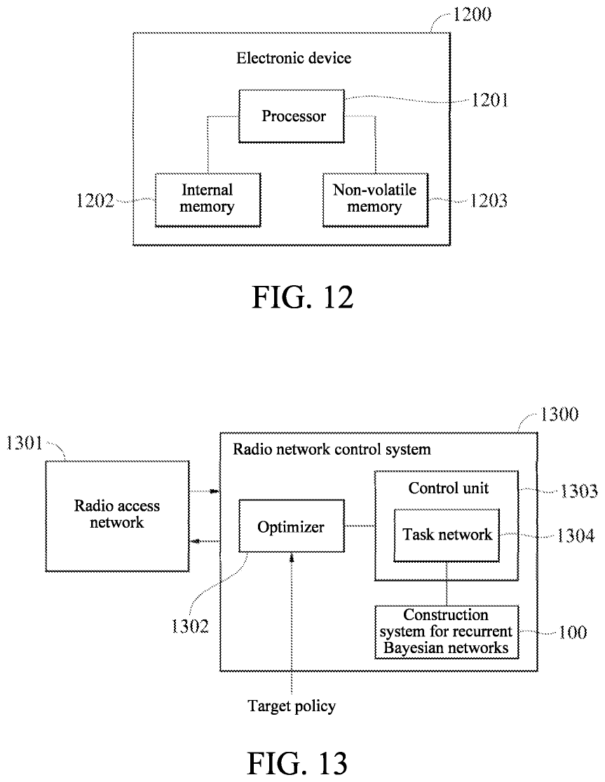

FIG. 12 is a structural block diagram of an electronic device according to an embodiment of this specification. As shown in FIG. 12, at a hardware level, an electronic device 1200 includes a processor 1201, an internal memory 1202, and a non-volatile memory 1203. The internal memory 1202 is, for example, a random access memory (RAM). The non-volatile memory is, for example, at least one disk memory. Certainly, the electronic device 1200 may further include hardware required for other functions.

The internal memory 1202 and the non-volatile memory 1203 are used to store programs. The programs may include program code, and the program code includes computer operation instructions. The internal memory 1202 and the non-volatile memory 1203 provide instructions and data to the processor 1201. The processor 1201 reads a corresponding computer program from the non-volatile memory 1203 into the internal memory 1202 and runs the corresponding computer program. The processor 1201 is specifically configured to perform the steps described in FIG. 9 to FIG. 13.

The processor 1201 may be an integrated circuit chip with a signal processing capability. During implementation, the method and steps disclosed in the foregoing embodiments may be implemented by using a hardware integrated logic circuit in the processor 801 or implemented by using instructions in a software form. The processor 1201 may be a general purpose processor, including a central processing unit (CPU), a digital signal processor (DSP), an application-specific integrated circuit (ASIC), a field-programmable gate array (FPGA) or another programmable logic device that may implement or perform the methods and steps disclosed in the foregoing embodiments.

Embodiments of the present specification further provide a computer-readable storage medium. The computer-readable storage medium stores at least one instruction, the at least one instruction, when executed by the processor 1201 of the electronic device 1200, causing the processor 1201 of the electronic device 1200 to perform the methods and steps disclosed in the foregoing embodiments.

Examples of computer storage media include, but are not limited to, a phase change memory (PRAM), a static random access memory (SRAM), a dynamic random access memory (DRAM), or other types of random access memory (RAM), a read-only memory (ROM), an electrically erasable programmable read-only memory (EEPROM), a flash memory or another internal memory technology, a compact disc read-only memory (CD-ROM), a digital versatile disc (DVD) or another optical storage, or a cartridge tape. A magnetic storage of a magnetic tape or a disc, another magnetic storage device, or any other non-transmission medium may be configured to store information that can be accessed by a computing device. As defined herein, the computer-readable medium does not include a transitory medium, such as a modulated data signal and a carrier wave.

FIG. 13 is a block diagram of a radio network control system in which a task network generated by the construction system for recurrent Bayesian networks is applied. Referring to FIG. 13, the radio network control system 1300 is externally coupled to a radio access network (RAN) 1301. The radio network control system 1300 includes a construction system 100 for recurrent Bayesian networks, an optimizer 1302, and a control unit 1303. The optimizer 1302 is configured to receive a network state of the RAN 1301 and receive an external target policy. The optimizer 1302 is configured to output an optimal configuration to the RAN 1301 for configuring and optimizing the RAN 1301. The control unit 1303 is configured to receive and store a task network 1304 from the construction system 100 for recurrent Bayesian networks. The construction system 100 for recurrent Bayesian networks generates the task network 1304 by using pre-acquired data and the fitness function related to the RAN 1301. The task network 1304 supports Causal Reasoning Model level II (intervention) and level III (counterfactual). Therefore, the task network 1304 can be used to answer what-if questions such as “Given time series RAN configuration feature vectors, what KPIs will the RAN 1301 achieve?”

The optimizer 1302 inputs a plurality of configuration feature vectors of each solution to the control unit 1303 based on a plurality of solutions in a solution space. The task network 1304 then evaluates the input KPI of each configuration feature vector to obtain a KPI value for each configuration feature vector. The optimizer 1302 selects an optimal solution in the solution space for each configuration feature vector based on the KPI value. The optimizer 1302 outputs the optimal configuration to the RAN 1301 based on the optimal solution.

In some embodiments of the present invention, components of each configuration feature vector include a topological structure, a routing table, a traffic intensity matrix, and a power strength matrix of the RAN.

In some embodiments of the present invention, the KPI is selected from one of a delay indicator, a jitter indicator, and a loss indicator, or a combination thereof.

In some embodiments of the present invention, the RAN 1301 is a 5G RAN.

Based on the above, some embodiments of the present invention provide a construction system and construction method for recurrent Bayesian networks, a computer-readable recording medium, and a non-transitory computer program product, which may efficiently construct an appropriate recurrent Bayesian network by evolving a population consisting of a CPPN.

Some embodiments of the present invention provide a radio network control system that can automatically complete a self-organizing network solution by applying a task network generated by the construction system for recurrent Bayesian networks.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A construction system for recurrent Bayesian networks, comprising a processor, the processor being configured to perform the following steps to generate a task network:
(a) setting a current population, the current population comprising a plurality of compositional pattern-producing networks (CPPNs);
(b) establishing a corresponding recurrent Bayesian network for each CPPN in the current population, to obtain a set of recurrent Bayesian networks corresponding to the current population;
(c) evolving the current population by using an evolutionary algorithm and a fitness function to obtain a next population, and setting the next population as the current population;
(d) determining whether a termination condition is met according to the fitness function and the set of recurrent Bayesian networks corresponding to the current population; and
(e) repeatedly performing steps (b), (c), and (d) in response to the termination condition being not met, and selecting a solution network in the current population as the task network based on the fitness function in response to the termination condition being met.

2. The construction system for recurrent Bayesian networks according to claim 1, wherein step (b) comprises:
selecting a current CPPN in the current population; and
establishing, by using an output generated by the current CPPN corresponding to an offspring node and a parent node corresponding to the offspring node in the corresponding recurrent Bayesian network, a conditional probability table of the parent node corresponding to the offspring node in the corresponding recurrent Bayesian network.

3. The construction system for recurrent Bayesian networks according to claim 2, wherein the evolutionary algorithm is neuroevolution of augmenting topologies.

4. The construction system for recurrent Bayesian networks according to claim 1, wherein the termination condition is steps (b), (c), and (d) are repeatedly for a default number of times, or, according to the fitness function, the current population comprises a candidate network allowing a fitness value of the candidate network to be greater than a preset fitness value.

5. The construction system for recurrent Bayesian networks according to claim 1, wherein step (a) comprises: randomly generating an initial population according to a parameter; and setting the initial population as the current population, wherein the initial population comprising the CPPNs.

6. A construction method for recurrent Bayesian networks, performed by a processor, to generate a task network, the construction method for recurrent Bayesian networks comprises:
(a) setting a current population, the current population comprising a plurality of compositional pattern-producing networks (CPPNs);
(b) establishing a corresponding recurrent Bayesian network for each CPPN in the current population, to obtain a set of recurrent Bayesian networks corresponding to the current population;
(c) evolving the current population by using an evolutionary algorithm and a fitness function to obtain a next population, and setting the next population as the current population;
(d) determining whether a termination condition is met according to the fitness function and the set of recurrent Bayesian networks corresponding to the current population; and
(e) repeatedly performing steps (b), (c), and (d) in response to the termination condition being not met, and selecting a solution network in the current population as the task network based on the fitness function in response to the termination condition being met.

7. The construction method for recurrent Bayesian networks according to claim 6, wherein step (b) comprises:
selecting a current CPPN in the current population; and
establishing, by using an output generated by the current CPPN corresponding to an offspring node and a parent node corresponding to the offspring node in the corresponding recurrent Bayesian network, a conditional probability table of the parent node corresponding to the offspring node in the corresponding recurrent Bayesian network.

8. The construction method for recurrent Bayesian networks according to claim 7, wherein the evolutionary algorithm is neuroevolution of augmenting topologies.

9. The construction method for recurrent Bayesian networks according to claim 6, wherein the termination condition is that steps (b), (c), and (d) are performed for a default number of times, or, according to the fitness function, the current population comprises a candidate network allowing a fitness value of the candidate network to be greater than a preset fitness value.

10. The construction method for recurrent Bayesian networks according to claim 6, wherein step (a) comprises: randomly generating an initial population according to a parameter; and setting the initial population as the current population, wherein the initial population comprising the CPPNs.

11. A computer-readable recording medium with a stored program, the stored program, when loaded and executed by a processing unit, performing the method according to claim 6.

12. A non-transitory computer program product, storing at least one instruction, the at least one instruction, when executed by a processor, causing the processor to perform the method according to claim 6.

13. A radio network control system, coupled to a radio access network, the radio network control system comprising:
a construction system for recurrent Bayesian networks, comprising a processor, the processor being configured to perform the following steps to generate a task network:
(a) setting a current population, the current population comprising a plurality of compositional pattern-producing networks (CPPNs);
(b) establishing a corresponding recurrent Bayesian network for each CPPN in the current population, to obtain a set of recurrent Bayesian networks corresponding to the current population;
(c) evolving the current population by using an evolutionary algorithm and a fitness function to obtain a next population, and setting the next population as the current population;
(d) determining whether a termination condition is met according to the fitness function and the set of recurrent Bayesian networks corresponding to the current population; and
(e) repeatedly performing steps (b), (c), and (d) in response to the termination condition being not met, and selecting a solution network in the current population as the task network based on the fitness function in response to the termination condition being met;
an optimizer, configured to receive a network state and a target policy of the radio access network, and output an optimal configuration to the radio access network for configuring and optimizing the radio access network; and
a control unit, configured to receive and store the task network; wherein the optimizer outputs, based on a plurality of solutions in a solution space, a plurality of configuration feature vectors of each solution to the control unit; the task network evaluates at least one key performance indicator (KPI) of each configuration feature vector to obtain at least one KPI value of each configuration feature vector; and the optimizer selects an optimal solution in the solution space based on the at least one KPI of each configuration feature vector, and outputs the optimal configuration to the radio access network based on the optimal solution.

14. The radio network control system according to claim 13, wherein components of each configuration feature vector comprise a topological structure, a routing table, a traffic intensity matrix, and a power intensity matrix of the radio access network.

15. The radio network control system according to claim 13, wherein the at least one KPI is selected from one of a group consisting of a delay indicator, a jitter indicator, and a loss indicator.

16. The radio network control system according to claim 13, wherein step (b) comprises:
selecting a current PCCN in the current population; and
establishing, by using an output generated by the current CPPN corresponding to an offspring node and a parent node corresponding to the offspring node in the corresponding recurrent Bayesian network, a conditional probability table of the parent node corresponding to the offspring node in the corresponding recurrent Bayesian network.

17. The radio network control system according to claim 16, wherein the evolutionary algorithm is neuroevolution of augmenting topologies.

18. The radio network control system according to claim 13, wherein the termination condition is that steps (b), (c), and (d) are repeatedly performed for a default number of times, or, according to the fitness function, the current population comprises a candidate network allowing a fitness value of the candidate network to be greater than a preset fitness value.

19. The radio network control system according to claim 13, and the construction system for recurrent Bayesian networks according to claim 1, wherein step (a) comprises: randomly generating an initial population according to a parameter; and setting the initial population as the current population, wherein the initial population comprising the CPPNs.
